(19) United States
(12) Patent Application Publication
(10) Pub. No.: US 2026/0265094 A1
(43) Pub. Date: Sep. 10, 2026

(54) ENERGY-SAVING DISINFECTION- AND OXIDATION SYSTEM FOR WATER TREATMENT

(71) Applicant: MERCAFORM HOLDING GMBH, Bonn (DE)

(72) Inventors: Bernd KOCHANNEK, Bonn (DE); Dominicus BRENDLER, Schkeuditz (DE)

(21) Appl. No.: 19/167,102

(22) PCT Filed: Mar. 27, 2024
(86) PCT No.: PCT/EP2024/058353

§ 371 Date: Sep. 19, 2025

(30) Foreign Application Priority Data
Mar. 28, 2023 (DE) 10 2023 107 863.1

(51) Int. Cl. C02F 1/74; C02F 1/32; C02F 1/72; C02F 101/10; C02F 103/00; C02F 103/02; C02F 103/34

(52) U.S. Cl. CPC C02F 1/74; C02F 1/325; C02F 1/725; C02F 2101/101; C02F 2103/001; C02F 2103/02; C02F 2103/343; C02F 2201/002; C02F 2201/322; C02F 2303/02; C02F 2303/04

(57) ABSTRACT

The present invention relates to a device for disinfection and/or oxidation in water-treatment applications. In particular, the new type of device can be used for drinking water for human and animal consumption or for process water and cooling water for industrial applications. The invention also relates to a method to use for keeping water pipelines, nozzles and pipes clean in various applications such as horticulture, agriculture and aquaculture.

The present invention describes a device for disinfection and/or oxidation in water treatment applications. In particular, the novel device finds application in drinking water for human and animal consumption or process and cooling water for industrial applications. Furthermore, a method for keeping water pipes, nozzles, and tubes clean in various applications such as horticulture, agriculture, and aquaculture is described. The system is also suitable for controlling pathogens in the food chain, for example, during the washing of vegetables or meat carcasses. The method is also suitable for keeping recreational water systems such as swimming pools and spas clean of pathogens. Furthermore, it is useful for disinfecting wastewater and purifying various wastewaters through oxidation. All this is achieved reliably and simply, with very low energy consumption compared to existing systems and without the use or addition of chemicals, thus avoiding harmful residues from chemical disinfection, such as those resulting from the use of chlorine, bromine, or their derivatives.

A key component of water quality is ensuring safe and wholesome water that is free from harmful microorganisms, residues, and contaminants. This is traditionally achieved by monitoring the number of indicator bacteria, for example, when drinking water is introduced into the distribution network, and by other quality markers such as appropriate pH and alkalinity levels and/or biological or chemical oxygen demand (BOD or COD) and/or dissolved oxygen (DO), as appropriate and as needed. General information for drinking water can be found, for example, in the Environmental Protection Agency (EPA) publication, Water Treatment Manual: Disinfection (2011). For drinking water, the EPA handbook emphasizes that microbial threats to the drinking water supplies may result from possible contamination by harmful microorganisms, including human and animal excrement. Typically, these microorganisms are classified as bacteria, viruses, protozoa, and helminths (i.e., parasitic worms). Chemical disinfection methods, as described in the publication Publisher: Kemira Oyj, “About water treatment”, ISBN 978-951-97173-9-5, include, for example, the following:
Chlorine or hypochlorous acid is widely used for both primary disinfection and for maintaining a residual level in distribution systems. Limitations associated with chlorination include byproducts and taste and odour issues.
Chlorine dioxide—a more powerful oxidizer than chlorine; in its pure form, chlorine dioxide does not form trihalomethanes (THMs), but may have dose-dependent limitations due to inorganic by-products (chlorate and chlorite).

Monochloramine—produced on-site by the reaction of ammonia and chlorine, a process known as chloramination. This substance does not form THMs, but is unsuitable as a primary disinfectant.
Ozone—a powerful oxidizer and disinfectant compared to chlorine or chlorine dioxide, but is considered more expensive and entails higher investment and operating costs.
Hydrogen peroxide and peroxone (hydrogen peroxide and ozone)—Although hydrogen peroxide is a strong oxidizing agent, it has relatively poor disinfection performance, although its performance can be improved by combining it with ozone.

DE10040566A1 describes a method for disinfecting drinking water by exposure to ultraviolet (UV) radiation in a water system (1). The water is exposed to UV radiation within a specific wavelength range (S1-S2) emitted by an artificial source. The water flows around the UV source, in the vicinity of which oxygen is simultaneously released and converted into ozone by the UV radiation. An independent claim is also included for an upright disinfection arrangement in which an oxygen supply is delivered with water into an annular chamber (3), which surrounds the UV source (2). The oxygen-enriched water (W) enters a second radially outer chamber (4), where it undergoes UV treatment and then contacts the resulting ozone. Water can be treated repeatedly using the same process before being released for use. The water treated with a combination of UV radiation and ozone is delivered to a point of use. A suitable assembly comprises an upright UV-ozone reactor (10) with a low-pressure mercury UV emitter with a straight tube (2). The emitter is located in a cylindrical vessel (6) with an air/oxygen supply (8) and an ozone outlet (9) to the second cylinder. The first cylinder is surrounded by a second concentric vessel (7) with a water inlet (11) and outlet (12).

DE10064 064A1/WO0249969A2 relates to a method for accelerating biocatalytic and/or hormonal processes in substances. This method is based on activating water with singlet oxygen before and/or during process development. This can be the water contained in the substance or an aqueous medium that is then added to the substance. One application example of the method according to the invention is the acceleration of biocatalytic and/or hormonal processes in soil.

DE102004010656A1/WO2005082791A1 relates to a method and device for treating organically and/or biologically contaminated water and/or contaminated air by intensively treating water and/or air with positive and negative oxygen ions as oxidizing agents, which are generated in an ionizer. This goal is to be achieved by a process in which: Using a blower/compressor, air is drawn through a filter, swirled in a tubular ion generator, and the oxygen molecules are ionized at a voltage of 2,300 V to 6,400 V and at frequencies of 25 Hz to 580 Hz. With a pulse frequency of 4,000 to 16,000 Hz, the air is introduced and distributed over a large area of the medium to be treated via a discharge system with electrostatically charged particles. The optimal working range is controlled by measuring the ion intensity using an ion measuring probe and a control system adapted to it

DE10014833A1 relates to a method and a device for the treatment of mechanically, organically and/or biologically contaminated water (raw water) by intensive treatment of the water with air as an oxidizing agent. Accordingly,

the treatment of mechanically, organically and/or biologically contaminated water (raw water) is to be achieved by intensive treatment of the water with air as an oxidizing agent, whereby
the raw water is fed into a reactor via a reactor,
the filter is charged to positive and negative oxygen ions with activated air via a frit at a pressure of 1.2-3.5 bar for several minutes into the water-filled reactor chamber and
the water treated in this way is then subsequently treated by post-filtration.

In DE20122005U1, raw water is passed through filters and then into a reactor. An ionizer is used to activate the air to charge it with positive and negative oxygen ions.

The ionized air is then passed through a sintered material at 1.2-3.5 bar for several minutes into the water filling the reactor. The treated water is then further filtered.

U.S. Pat. No. 9,617,177B2 describes a water treatment device and methods for treating water, such as cooling tower water, agricultural water, water used in oil and/or gas production, swimming pool water, and water for hot tubs or spas. The water treatment device uses ultraviolet radiation, a magnetic field, and ozone-enriched air to treat the water, typically resulting in lower microbial contamination and lower alkalinity in the cooling tower water. The cooling tower water can consequently be operated at higher concentration cycles while reducing or completely eliminating mineral deposition on the cooling tower components. Swimming pool and hot tub water treated with the water treatment device typically requires less chlorine, and chlorine levels are generally more stable than without the device.

The removal of hazardous pollutants from wastewater is described by Shivathar-siny Rasalingam, Rui Peng, and Ranjit T. Koodali in “Applications of TiO2-SiO2 Mixed Oxide Materials,” Hindawi Publishing Company, Journal of Nanomaterials, Volume 2014, Article ID 617405. Advanced oxidation processes (AOP) have subsequently gained considerable attention due to the prospect of completely mineralizing non-biodegradable organic matter into environmentally safe products through chemical oxidation. Heterogeneous photocatalysis, in particular, has shown great promise for water purification and the treatment of various pollutants, including naturally occurring toxins, pesticides, and other harmful contaminants. This work investigated the various removal methods used for water purification. In particular, the application of binary TiO2-SiO2 mixed oxide materials for wastewater treatment is discussed here. The literature review shows that these mixed oxide materials can photocatalytically remove a wide range of pollutants. The absorption of TiO2 is limited to the UV range, thus only utilizing a small part of the solar spectrum. The TiO2-SiO2 mixed oxide photocatalysts have demonstrated significantly increased activities compared to pure TiO2.

U.S. Pat. No. 5,503,800A describes an ultraviolet sterilization system for wastewater. A device for irradiating a liquid with bactericidal radiation is disclosed. The device comprises a source of ultraviolet radiation and an opaque housing enclosing the source of ultraviolet radiation to prevent exposure of the source to the liquid and to allow exposure of the liquid to the radiation. Channels are provided that conform to the shape of the housing. Projections are formed in the channels to create a turbulent plug flow so that when the device is inserted into a stream of liquid to be treated, the channels serve to confine and direct the liquid around the housing, and the projections serve to create a continuous, cyclic flow in the channels between the housing and the channel walls to ensure that the liquid is exposed to a lethal dose of ultraviolet radiation from the source. Methods are also disclosed in which the device is used to expose a liquid to bactericidal radiation.

All of the above-mentioned treatment methods, with the exception of ozone, which is usually generated on-site, involve high costs for handling hazardous substances. Chlorine and its derivatives produce undesirable and harmful residues, known as disinfection by-products. Standard ozone generators are only suitable in certain cases due to their size and the high energy requirements for ozone generation.

Non-chemical methods of water disinfection are exemplified by various irradiations, the most common of which is ultraviolet (UV) irradiation of water with a UV-C light source. This method typically uses UV wavelengths of around 254 nm, as this is the most germicidal wavelength known. However, this method has significant shortcomings. The UV light does not penetrate large volumes of water and is not effective in disinfecting there, as the light is scattered and adsorbed, and the effect is even less effective if the water to be treated is not absolutely free of turbidity, colour, or particles. It also offers only a limited and temporary remedy, as it lacks any residual downstream activity like a chemical oxidizer. One such UV disinfection system with a 254 nm wavelength is described, for example, in U.S. Pat. No. 5,503,800.

Another problem for all current disinfection and wastewater systems is the formation of scale in pipes. This scale is typically a divalent metal carbonate deposit that provides a breeding ground for microorganisms that can then multiply. Often, when such microorganisms adhere en masse to the scale on pipe or tank surfaces, they secrete exopolymeric substances (EPS), forming a protective site called a biofilm. The microbes in pipes, tanks, and irrigation systems within these protected sites are unaffected or only marginally affected by conventional water treatment methods such as chlorine, chlorine dioxide, ozone, peroxide, peracetic acid, UV irradiation, and other approved treatments used at permitted application rates. It is therefore crucial that the water used for washing, cooling, transport, post-harvest washing, for example, or other processes is kept in a condition that is not conducive to the deposition of scale on surfaces, thereby preventing a breeding ground for biofilm development.

The object of the present invention is to overcome the aforementioned disadvantages of the state of the art and to provide a more effective method for disinfecting and treating water.

In a first embodiment, the present invention describes a device for disinfecting and treating water, in particular by oxidation, using a gas stream containing activated oxygen comprising a reactor having a reactor chamber and a gas inlet and a gas outlet and a vacuum UV radiation source located therein, wherein the surface of the reactor chamber at least partially comprises a catalytically active material made of transition metals of the periodic table of the elements for generating reactive oxygen species.

An activated gas stream, in particular an activated air stream, is understood according to the invention to mean streams comprising highly reactive oxygen species with very high oxidation potential. An overview of reactive oxygen species that can be obtained from oxygen is provided by Katerina Krumova and Gonzalo Cosa (in Singlet Oxygen: Applications in Biosciences and Nanosciences, Volume 1, 2016, pp. 1-21 DOI: 10.1039/9781782622208-00001). Reactive oxygen species derived from molecular oxygen (O2) can be listed as follows:
Singlet oxygen (^{X}O2); superoxide (O2°′); peroxide ion (O2⁻²); Perhydroxyl radical (HO2°); Hydroxyl radical (HO°), ozone (O3)

By means of the present invention, at least one of the following water treatment objectives can be achieved, such as disinfection, reduction of chemical oxygen demand (COD), reduction of biological oxygen demand (BOD), removal of undesirable oxidizable organic compounds, cleaning of pipes and water lines from biofilm, reduction of scale deposits on pipes and equipment, increase of dissolved divalent metal cations in aqueous solution, reduction of viral and bacterial load, reduction of iron and manganese ions in the water, increase of dissolved oxygen (DO) and/or control of alkalinity in the water.

According to the invention, the device comprises a UV radiation source. In particular, preferred embodiments of the present invention utilize ultraviolet (UV) light of specific wavelengths in a reaction chamber made of a surface comprising catalytically active material to generate such reactive oxygen species with a high redox potential (ORP), which are useful in the treatment, purification, and disinfection of water streams. According to the invention, it was surprisingly discovered that the catalytic material of the reaction chamber should be a transition metal, into which short-wavelength UV light is introduced and through which a gas stream, in particular an air stream, is passed. (See FIG. 1) An oxygen-enriched gas stream, in particular, air flow or even pure oxygen can also be used as raw material feed to the system; but for most applications, air is preferred due to its ease of handling, wide availability, and low cost. The suitable wavelength for the catalytic activation of an air or oxygen stream in the transition metal reaction chamber to form reactive oxygen species is light from the short-wave UV spectrum, preferably below the visible light spectrum and above the wavelength of X-rays. In particular, a UV wavelength shorter than UV-A and UV-B light is required, and is sometimes referred to as UV-C and vacuum UV (VUV). VUV radiation stands for vacuum ultraviolet radiation or vacuum ultraviolet radiation and, according to Wikipedia, refers to the spectral range of electromagnetic radiation whose long-wavelength region borders on the so-called near-UV. It owes its name to the fact that the radiation is absorbed by the oxygen in the air and thus requires a vacuum to propagate. The spectral range is not precisely defined, as conflicting definitions exist, e.g. 10-200 nm or 100-200 nm. The short-wave end of the VUV spectral range borders on the EUV radiation range, or soft X-rays, depending on the definition. In existing technology for UV irradiation of water for disinfection, the lamps usually use a wavelength close to 254 nm, as this type of light acts directly on the microbial cell walls and most efficiently denatures the DNA of the microorganisms, thereby disinfecting the water stream. Commercially available UV lamps with short-wave UV-C and VUV emissions are usually designed so that the lamp glass filters out the shortest wavelengths, thus optimizing emissions in the 254 nm range. However, to obtain the effect of the present inventions, the shorter VUV range must be present for optimal performance. In particular, the presence of wavelengths around the 185th mark is necessary for an optimal result according to the present invention. Therefore, a preferred device of the invention particularly preferably comprises a UV radiation source with wavelengths of >100 and <300 nm. Most preferably, the UV radiation source comprises light with a wavelength of the UV-C type of the light spectrum and below, but above, the X-ray spectrum, namely in the range from 150 nm to 280 nm.

In particular including the wavelength around 254 nm and 185 nm and in particular around 185 nm.

The internal surfaces of the reaction chamber, particularly the metal surfaces of the reaction chamber, are preferably polished to enhance the emitted UV light through mirror-like reflection. Furthermore, the metal should preferably not significantly alter the reflected wavelength, be corrosion-resistant to the reactive oxygen species generated in the gas or air stream, and be durable with high mechanical strength. Surprisingly, the preferred, though not exclusive, material for achieving the objectives of the present invention is stainless steel, which has a catalytic effect on the formation of reactive oxygen species and is also widely available and affordable. Stainless steel, such as type V2A, V4A, or the like, is known to be an alloy consisting primarily of iron (Fe) with smaller amounts of other transition metals such as chromium (Cr), cobalt (Co), manganese (Mn), nickel (Ni), and some non-metallic components. While iron and the other transition metals are components of some chemical and biological catalytic compounds, the catalytic activity of a stainless steel alloy towards an air or oxygen stream under UV irradiation is unknown to the person skilled in the art. Furthermore, the surprising catalytic effect is not universally valid for metals in general, since if the reaction chamber is made of a main group metal, such as aluminium, no activation of the air or the oxygen stream to reactive oxygen species with a high redox potential occurs. Even if the reaction chamber is coated with a catalytic transition metal such as stainless steel, the catalytic activity decreases or disappears. Accordingly, within the meaning of the present invention, it is preferred if not only the surface of the reaction chamber comprises a transition metal or a metal alloy made of stainless steel, in particular consists thereof, but the material of the reaction chamber also comprises a transition metal or a metal alloy made of stainless steel in its depth, in particular consists thereof.

The water treatment and purification device according to the invention is particularly suitable for the use of ambient air, wherein the atmospheric oxygen is activated in a reaction chamber by UVC light of specific wavelength(s) utilizing the catalytic effect emanating from the material of the reaction chamber to generate reactive oxygen species.

This air, which contains the reactive oxygen, is then dispersed in a raw water stream, increasing the redox potential (ORP) to high values. This high ORP is capable of disinfecting a water stream and oxidizing the contaminants contained in the water stream without the need for chemicals or biocides. The process reduces the microbial load to a very high level and makes it possible to produce drinking water quality for human and animal consumption or high-quality process or cooling water for industrial applications. The device also finds application in the cleanliness of water pipes in horticulture, agriculture, and aquaculture and can be used to control pathogens in washing processes in the food chain. The device is also suitable for the cleanliness and disinfection of water systems in recreational facilities such as swimming pools and spas. The system consumes very little energy. To accelerate the gas flow through the reaction chamber, the device according to the invention can further comprise an air pump or a Venturi system.

In a further embodiment, the present invention describes a method for disinfecting and treating water, in particular by oxidation, using an activated oxygen-containing gas stream in a reactor having a reactor chamber and a gas inlet and a gas outlet, and a vacuum UV radiation source located therein, wherein the surface of the reactor chamber at least partially comprises a catalytically active material made of transition metals of the Periodic Table of the Elements for generating reactive oxygen species, wherein the gas stream, in particular of air or oxygen or a mixture of air and oxygen, is passed through the reaction chamber and the activated gas stream is subsequently brought into contact with the water to be treated. In principle, this embodiment therefore represents the intended use of the device defined above.

For controlling and monitoring oxidative processes, such as drinking water chlorination or ozonation, a common tool is the measurement of the oxidation-reduction potential (ORP), sometimes also called redox potential. It is measured by an electrode in millivolts (mV) and indicates the potential of one substance to oxidize or reduce another. The US Centers for Disease Control and Prevention (CDC) defines ORP as follows: “The oxidation-reduction potential (ORP) is a measure of the tendency of a solution to either gain or lose electrons; a higher (more positive) oxidation-reduction potential indicates a more oxidizing solution.” (2018 Model Aquatic Health Code) For example, when disinfecting drinking water, the general guidelines for the minimum ORP value should not be less than 600 mV measured directly after 30 cm to 1.5 m, and the maximum ORP value should not be more than 900 mV.

The WHO states: “The measurement of oxidation-reduction potential (ORP or redox potential) can also be used for operational monitoring of disinfection effectiveness. It is possible to define a minimum ORP value required to ensure effective disinfection. This value must be determined on a case-by-case basis; universal values cannot be recommended. Further research and evaluation of ORP as an operational monitoring technique are highly desirable.”

However, the Australian government states in a fact sheet that “drinking water is adequately disinfected at an ORP of 650 mV.” It further states: “In swimming pools, an ORP of 700 to 720 mV allows for both rapid disinfection and breakpoint chlorination (destruction of chloramines) when conditions permit (and chlorine is used).”

The oxidation-reduction potential is the potential (the voltage in millivolts mV) at which oxidation occurs at the anode and reduction at the cathode of an electrochemical cell. Simply put, from a microbial perspective, an oxidizing chemical steals electrons from the cell membrane, causing it to destabilize and leak. The destruction of the cell membrane's integrity leads to rapid death. Similar to a digital thermometer or pH probe, ORP sensors allow for easy monitoring and tracking of critical disinfectant levels in water systems. A detailed description of ORP in water hygiene can be found in “Oxidation-Reduction Potential (ORP) for Water Disinfection Monitoring,” Control, and Documentation by TREVOR V. SUSLOW, Extension Research Specialist, Department of Vegetable Crops, University of California, Davis.

The guideline values given in Table 1 below provide an overview of the ORP and the required disinfection times to achieve disinfection for different bacterial species:

TABLE 1
Summary of results from various laboratory simulations
and commercial water cooler systems.

| | Survival time in seconds (s) or hours (h) at ORP (mV) | | | | |
|---|---|---|---|---|---|
| Pathogenic | <485 mV | | 550 < x <620 mV | | >665 mV |
| E. coli 0157:H7 | >300 | s | <60 | s | <10 s |
| Salmonella Spp. | >300 | s | >300 | s | <20 s |
| Listeria monocytogenes | >300 | s | >300 | s | <30 s |
| Thermotolerant coli bacteria | >48 | hours | >48 | hours | <30 s |

FIG. 2 shows results with a water treatment system of the present invention, which provides very high ORP values compared to alternative examples, thus demonstrating the advantage and high performance of the device and method according to the invention compared to existing technology.

In addition to ORP measurement, the presence of some reactive oxygen species can also be analytically investigated. Such tests, for example for peroxide and OH° radicals from peracids, are offered, for example, by Merck KGaA. The Merck peroxide test uses the enzyme peroxidase to transfer the peroxygen to an organic redox indicator, which turns blue, thus indicating the presence of peroxide, while the peracid test uses the oxidizing power of very strong oxidants such as OH° radicals from the oxidative decomposition of peracids to oxidize an aromatic amine, which then turns blue, thus indicating the presence of said strong oxidants. These methods are also available as semi-quantitative dip strip tests. When applied to water treated with the present invention, both tests give positive results and the indicator turns blue, confirming the presence of reactive oxygen species when using the water treatment system of the present invention.

The catalytic activity of the material constituting the reaction chamber of the present invention, as well as the specific UV wavelengths around 254 and 185 nm, generate an airflow with high disinfection and oxidation performance while requiring very low power. Pressure buildup in the reaction chamber is not required but is possible within the scope of the invention. The UV emission lamps can be standard UV-C types, provided that care is taken to ensure that the bulb glass is designed so that the shorter wavelengths in the 185 nm range are not filtered out, or they can be special ozone-generating UV lamps with a 185 nm wavelength.

FIG. 3 shows a photograph of an untreated pipe section with deposits (left) and after 48 hours of immersion in high ORP water treated by the present invention (right).

In a preferred embodiment of the present invention, the apparatus and method are suitable for treating water streams in the following applications:
a. Drinking water for human and animal consumption
b. Cooling and/or process water for industry,
c. Treatment of recreational waters such as swimming pools, pools and spas,
d. Treatment and disinfection of municipal wastewater,
e. Treatment of industrial wastewater,
f. Removal of pharmaceutical residues from wastewater,
g. Treatment of pipes and water systems in horticulture and greenhouses,
h. Water treatment in aquaculture,
i. Washing processes in the food chain and/or
j. Odour control in sewers and wastewater streams.

The strong oxidizing power of the air, oxygen or oxygen-enriched gas stream containing reactive oxygen species according to the present invention contains, has a variety of applications in the field of water treatment, which are explained below, but are not limited to:
Drinking water for human consumption, wherein the system of the present invention enables disinfection without harmful disinfection by-products (such as those produced by chlorine)
Process and cooling water for industrial processes, where the system of the present invention ensures hygiene and the reduction of deposits and scale
Treatment of pipelines and irrigation systems in agriculture and horticulture, including greenhouses, wherein the system of the present invention keeps pipes, drip hoses, sprinkler systems and nozzles free of deposits and biofilm
Drinking water for animals on farms, wherein the system of the present invention keeps pipes and drip lines clean of deposits and biofilm while providing disinfected water that reduces disease and mortality rates and improves healthy growth and weight gain.
Treatment and disinfection of recreational waters such as swimming pools, spas and whirlpools, wherein the system of the present invention provides a hygienic, safe and healthy environment.
Washing food with high ORP water from the system of the present invention to ensure hygienic cleaning of food such as vegetables, meat or animal carcasses in slaughterhouses, the system contributing to the safety of the food chain
Treatment of waste water in which the system of the present invention enables the reduction of the chemical or biological oxygen demand (COD or BOD) and the elimination of certain undesirable oxidizable residues, such as drug residues or endocrine disruptors.
Treatment of municipal wastewater for final disinfection prior to discharge of the treated wastewater into sensitive waters, wherein the system of the present invention enables cost-effective reduction of pathogens.
Water treatment in aquaculture to stabilize dissolved oxygen levels and pH and to provide healthy, low-germ water for crustacean and/or fish farms
Removal of odours, especially hydrogen sulfide (H2S), from sewers by oxidation.

Particularly preferably within the meaning of the present invention, the treated gas stream is brought into contact with the water stream by mechanical methods, in particular injection diffusers, mixers—including static mixers in tubes-, microbubble-generating aeration diffusers made of porous stone or porous aeration diffusers made of ceramic and/or venturi and/or ultrasonic sounding systems.

### EXAMPLES OF IMPLEMENTATION

### Comparison Example 1

### UVC Light Through V2A Stainless Steel Cylinder

A 30 l/min diaphragm air pump was used to direct an air flow through a stainless steel metal cylinder into a porous air diffuser, which generated microbubbles in a 100 l barrel of tap water with a pH of 7.6 and an initial ORP of 131 mV. A UVC light source within the metal cylinder emitted UV light at a wavelength of 254 nm. The pH of the water did not change, and the redox potential increased only slightly to 288 mV after 90 minutes. This demonstrates that the activation of atmospheric oxygen by UV light with a wavelength as low as 254 nm does not result in activated air with sufficient oxidation potential for use in disinfection and water treatment. Merck peroxide and peracid test strips showed no signs of colouration in the treated water.

### Comparison Example 2

### UVC/VUV Through Aluminium Cylinder

A 30 l/min diaphragm air pump was used to direct an air flow through an aluminium metal cylinder into a porous air diffuser, which generated microbubbles in a 100-litre barrel of tap water with a pH of 7.6 and an initial ORP of 190 mV. A UVC light source within the metal cylinder emitted UV light at wavelengths of 254 nm and 184 nm. The pH of the water did not change, and the redox potential increased only slightly to 327 mV after 90 minutes. This demonstrated that the activation of atmospheric oxygen by UV light at wavelengths of 185 and 254 nm in cylinders made of inert, non-catalytic materials such as aluminium does not produce activated air with sufficient oxidation potential for use in disinfection and water treatment. In the treated water, Merck's peroxide and peracid test strips showed no signs of colouration.

### Comparison Example 3

### UVC/VUV Through TiOz Coated Cylinder

A diaphragm air pump with a capacity of 30 l/min was used to direct an air flow through an aluminium metal cylinder coated with nanoparticulate titanium dioxide (TiO2) into a porous air diffuser, which generated microbubbles in a barrel containing 100 litres of tap water with a pH of 7.6 and an initial ORP of 190 mV. UVC light source within the metal cylinder emitted UV light with a wavelength of 254 nm and 185 nm. The pH of the water changed to 8.0, and the ORP increased significantly to 545 mV after 90 minutes. This demonstrates that the activation of atmospheric oxygen by nanoparticulate TiO2-mediated photocatalysis, as described in the literature, achieves some advantageous results but is far inferior to the teachings of the present invention, as demonstrated in Inventive Example 1. In the treated water, the Merck peroxide test strips showed no signs of colouration, while the peracid test strips showed a very slight light blue colouration, indicating the presence of some reactive oxygen species.

### Comparison Example 4

### UVC/VUV Through Magnetic Field in Aluminium Cylinder

A diaphragm air pump with a capacity of 30 l/min was used to direct an air stream through an aluminium metal cylinder equipped with a series of magnetic ring pairs that generated a magnetic field, and into a porous air diffuser that generated microbubbles in a barrel containing 100 litres of tap water with a pH of 7.6 and an initial ORP of 168 mV. A UVC light source within the metal cylinder emitted UV light with a wavelength of 254 nm and 185 nm. The pH of the water changed to 8.1, and the redox potential increased significantly to 518 mV after 90 minutes. This demonstrated that the activation of atmospheric oxygen in a magnetic field by UV light, as described by David Kolsta in U.S. Pat. No. 9,617,177 B2, achieved some advantageous results, but was far inferior to the teachings of the present invention, as demonstrated in Inventive Example 1. In the treated water, the Merck peroxide test strips showed no signs of colouration, while the peracid test strips showed a very slight light blue colouration, which indicated the presence of some reactive oxygen species.

### Example 1

### Disinfection of Tap Water

A 30 l/min diaphragm air pump was used to direct an air flow through a stainless steel metal cylinder into a porous air diffuser, which generated microbubbles in a 100 l barrel of tap water with a pH of 7.6 and an initial ORP of 145 mV. A UVC light source within the metal cylinder emitted UV light at wavelength of 254 nm and 185 nm. The pH of the water rose to 8.2, and the ORP increased to 745 mV after 90 minutes. This demonstrated that air activation by the system of the invention is far superior to the state of the art and rivals the ORP of chlorine, the most potent chemical disinfectant commonly used in water treatment. In the treated water, the Merck peroxide test strips for peracid and peroxide both showed a significant change to a bluish colour, clearly indicating the presence of reactive oxygen species.

### Example 2

### Meat Disinfection Rinse

A 60 l/min diaphragm air pump was used to direct an air flow through a stainless steel cylinder into a porous air diffuser, which generated microbubbles in a 100 l barrel of tap water with a pH of 7.4 and an initial ORP of 165 mV. A UVC light source within the metal cylinder emitted UV light with a wavelength of 254 nm and 185 nm. After 4 hours, the pH of the water rose to 8.13 and the ORP rose to 806 mV. A piece of fresh chicken breast from a local supermarket was contacted with a total viable count dip from Merck Millipore. The same chicken breast was then immersed in the water described above for 60 seconds, drained, and contacted with another total viable count slide. Both slides were stored in an incubator at 30° C. for three days. While the slide had a colony count of 120 before washing, the slide showed no colony count after washing. This demonstrated that the high ORP water resulting from treatment with the present invention is suitable for meat disinfection and carcass washing, and has the advantage of leaving no chemical residues in the meat.

### Example 3

### Wastewater Treatment

A 60 l/min diaphragm air pump was used to direct an air flow through a stainless steel metal cylinder into two porous air diffusers, generating microbubbles in an IBC containing 1000 litres of contaminated industrial wastewater with a pH of 7.4, a chemical oxygen demand (COD) of 820 mg/L, and a dissolved oxygen content (DO) of zero. A UVC light source within the metal cylinder emitted UV light with a wavelength of 254 nm and 185 nm. After two hours of treatment, the pH had increased to 8.2, while the COD had decreased to 300 mg/L and the DO had increased to 5 mg/L. This example demonstrated that the present invention can be a useful component in a contaminated wastewater treatment system.

### Example 4

### Reduction of Pharmaceutical Residues in Wastewater

A 60 l/min diaphragm air pump was used to direct an air flow through a stainless steel metal cylinder into two porous air diffusers, generating microbubbles in a 200-litre barrel of wastewater containing 4.5 μg/l of 2-[2-(2,6-dichlorophenylamino) phenyl]acetic acid (also known as Voltaren®) and 0.9 μg/l of 5H-dibenz[b,f]azepine-5-carbamide (also known as Tegretol®). A UVC light source within the metal cylinder emitted UV light with a wavelength of 254 nm and 185 nm. After 15 minutes of treatment, the values for Voltaren® and Tegretol® had decreased to <3 μg/l and <0.1 μg/l, respectively. This example demonstrates that the present invention can help degrade unwanted medical residues from wastewater.

### Example 5

### Treatment of Drinking Water in a Poultry Farm

A 60 l/min diaphragm air pump was used to direct an air flow through a stainless steel metal cylinder into two porous air diffusers, generating microbubbles in a 1000-litre IBC used as a buffer tank to supply the drinking water lines in a poultry house in a test run. A UVC light source within the metal cylinder emitted UV light wavelengths of 254 nm and 185 nm. After a 20-day growth period, bird mortality decreased by 3% and weight gain increased by 6% compared to the control. This example demonstrated that the present invention can disinfect animal drinking water, offering both performance and cost advantages to the farmer.

### Example 6

### Keeping Pipelines Clean

A 60 l/min diaphragm air pump was used to direct an air flow through a stainless steel metal cylinder into two porous air diffusers, generating microbubbles in a 200 l water barrel. A UVC light source within the metal cylinder emitted UV light at wavelengths of 254 nm and 185 nm, activating the air flow to generate an ORP value of 770 mV. A section of pipe with heavy deposits was immersed in the water for 48 hours. Photographs of the pipe before and after immersion showed a reduction in the deposits on the pipe (see FIG. 3). This example demonstrated that the present invention can keep equipment such as pipes clean of deposits.

### Example 7

Reduction of Hydrogen Sulfide from Sewers

A diaphragm air pump with a capacity of 100 l/min was used to force an air stream through a stainless steel metal cylinder via a hose. Within the metal cylinder, a UVC light source emitted UV light with a wavelength of 254 nm and 184 nm, activating the oxygen in the air. The air stream was directed upstream through the hose into a sewer, where a distinct odour of hydrogen sulfide (e.g., rotten egg odour) was present. Shortly after the air stream was metered in, the odour in the sewer subsided. This example demonstrated that the present invention can be used to combat hydrogen sulfide odour in sewers.

1. A device for disinfecting and treating water by oxidation, using a gas stream containing activated oxygen, comprising a reactor having a reactor chamber and a gas inlet and a gas outlet and a vacuum UV radiation source located therein, wherein the surface of the reactor chamber at least partially comprises a catalytically active material, made of transition metals of the Periodic Table of Elements, for generating reactive oxygen species.

2. The device according to claim 1, characterised in that the surface of the reaction chamber comprises a transition metal or a metal alloy made of stainless steel.

3. The device according to claim 1, characterised in that the surface of the reaction chamber is polished.

4. The device according to claim 1, characterised in that the UV radiation source emits light with wavelengths of >100 and <300 nm.

5. The device according to claim 4, characterised in that the UV radiation source emits light with a wavelength of the UV-C type of the light spectrum and below, but above the X-ray spectrum, in the range from 150 nm to 280 nm.

6. The device according to claim 1, further comprising an air pump or a venturi system.

7. A method for disinfection and treatment of water by oxidation, using an activated oxygen-containing gas stream in a reactor having a reactor chamber and a gas inlet and a gas outlet and a vacuum UV radiation source located therein, wherein the surface of the reactor chamber at least partially comprises a catalytically active material, made of transition metals of the Periodic Table of Elements, for generating reactive oxygen species, wherein the gas stream of air or oxygen or a mixture of air and oxygen is passed through the reaction chamber and the activated gas stream is then brought into contact with the water to be treated.

8. The method according to claim 7 for treating water streams.

9. The method according to claim 8, wherein the treated activated gas stream is brought into contact with the water stream by mechanical means, wherein mechanical means include injection diffusers, mixers, microbubble-generating aeration diffusers made of porous stone or porous aeration diffusers made of ceramic and/or venturi and/or ultrasonic sounding systems.

10. The method according to claim 7 for the treatment of water streams in the following applications:
a. Drinking water for human and animal consumption,
b. Cooling and/or process water for industry,
c. Treatment of recreational waters such as swimming pools, pools and spas,
d. Treatment and disinfection of municipal wastewater,
e. Treatment of industrial wastewater,
f. Removal of pharmaceutical residues from wastewater,
g. Treatment of pipes and water systems in horticulture and greenhouses,
h. Water treatment in aquaculture,
i. Washing processes in the food chain, and/or
j. Odour control in sewers and wastewater streams.

11. The device according to claim 4, characterised in that the UV radiation source emits light with a wavelength of the UV-C type of the light spectrum and below, but above the X-ray spectrum, in the range from about 185 nm and 254 nm.

12. The method according to claim 9, wherein the mixers include static mixers in tubes.
